(19) United States
(12) Patent Application Publication
(10) Pub. No.: US 2007/0113279 A1
(43) Pub. Date: May 17, 2007

(54) [PORTABLE STORAGE DEVICE]

(75) Inventors: Chih-Ling Wang, TAIPEI (TW); Yi-Hsiang Huang, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PHISON ELECTRONICS CORP., Chutung Town, Hsinchu Hsien (TW)

(21) Appl. No.: 11/164,170

(22) Filed: Nov. 14, 2005

(51) Int. Cl. H04L 9/32

(52) U.S. Cl. 726/20

(57) ABSTRACT

A portable storage device is provided. The portable storage device comprises a memory having a hidden block, a first program block, a general block and a security block. A user's password is stored in the hidden block and a password-identifying program is stored in the first program block. When a host executes the password-identifying program, the user is asked to input a password that is compared with the user's password stored in the hidden block. If the password inputted by the user matches with the user's password stored in the hidden block, the user is allowed to access to data stored in the security block and to process data retrieval/storage therein.

### BACKGROUND OF THE INVENTION

1. Field of the Invention

The present invention generally relates to a portable storage device, and more particularly to storage device comprising a memory, capable of keeping security to the separated blocks of the memory without installing any driver program in the host.

2. Description of Related Art

Flash memory has become highly popular because of its advantageous characteristics such as nonvolatile, shock proof, high density, and the like. Among many portable devices, flash memory has taken the place of EEPROM or the memory requiring battery. Because the semiconductor technology is mature, it is possible to promote both storage density and transmission speed of the flash memory, and therefore the flash memory has gradually replaced the conventional storage media, such as the hard disk driver. Because of the abovementioned advantages of the flash memory, manufacturers use the flash memory to develop portable flash memory storage device, enabling the user to save and retrieve data stored therein from any location. The convenience provided by the flash memory storage device is much more than the conventional storage device, and that is why the flash memory storage device has become very popular and indispensable tool.

Furthermore, a portable storage device with the super large capacity, high transmission speed and small size was invented to coordinate with the USB as a portable hard disk by combining the hard disk of the notebook computer or the desktop computer with the transmission interface. The portable hard disk is widely used for its capacity and transmission speed, the best among the storage devices with coordination with transmission interface, a large storage capacity is obtained, for example, from less than 10 GB up to several tens of GB allowing the user to conveniently store text, musical files, and long hours of multimedia programs and also operating system soft wares and other soft wares.

Because the storage device mentioned above is small and highly portable, the storage device may be easily misplaced or stolen. Therefore, some manufacturers developed secure system for accessing to the information stored in the storage device, using such as password or fingerprint, for protecting the information stored in the storage device. Even if the user looses the storage device, the information stored therein may be effectively protected. Such storage device with protection however requires a driver program to be installed in the host. Thus, the user not only has to carry the storage device but also has to carry the disk containing the driver program for executing the same in the host.

Furthermore, the abovementioned storage device with the protection is capable of only encoding or decoding a specific directory or file, and to protect information, the user has to save the data under the specific directory for protection. Because the encoding/decoding can not be implemented for the whole block of the disk, and therefore the user can not protect the entire information stored in the storage device.

Therefore, how to overcome the above defects of the conventional art is an important issue for the manufacturers in the field.

### SUMMARY OF THE INVENTION

According to an aspect of the present invention, the memory comprises the first program block that stores a password identifying for comparing a user's identity with the identity stored in a hidden block to determine whether or not allow the user to access the data stored in the security block and thereby effectively protect the data stored in the security block. Thus, the user may securely store important data in the storage device without installing any driver programs in the host.

According to an aspect of the present invention, the storage device of the present invention comprises a connecting interface connected to a microcontroller and a memory in an orderly manner. The memory comprises a hidden block, a first program block, a general block and a security block. The first program block comprises an identifying program. When the storage device is electrically connected to the host via the connecting interface, the storage device sets up the first program block and the general block as the available blocks, and the security block is set up as the unavailable block. The user may process data retrieval/storage in the general block. If the user wants to process data retrieval/storage in the security block, the identifying program stored in the first program block must be executed and the user is asked to input a user's identity that is compared with the identity stored in the hidden block. If the identity inputted by the user matches with the identity stored in the hidden block, the user can be allowed to access the data stored in the security block.

### BRIEF DESCRIPTION OF THE DRAWING

FIG. 1 is a block diagram of a storage device according to an embodiment of the present invention.

FIG. 2 is a flowchart of an operation procedure of the storage device according to an embodiment of the present invention.

FIG. 3 is a block diagram of the storage device according to another embodiment of the present invention.

FIG. 4 is a flowchart of an operation procedure of the storage device according to another embodiment of the present invention.

FIG. 5 is a block diagram of the storage device according to another embodiment of the present invention.

### DETAIL DESCRIPTION OF THE EMBODIMENTS

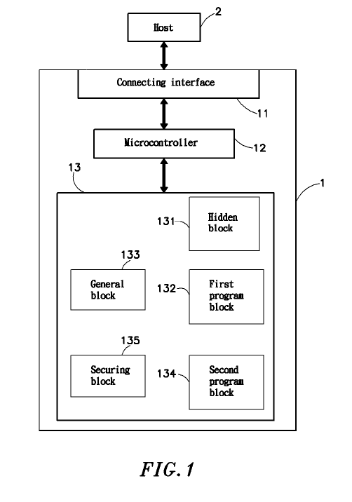

Referring to FIG. 1, a storage device 1 in accordance with the present invention is shown comprised of a connecting interface 11, a microcontroller 12 and a memory 13. The memory 13 comprises a hidden block 131, a first program block 132, a general block 133, a second program block 134 and a security block 135.

The connecting interface 11 is electrically connected to a host 2 and the connecting interface 11 can be a USB connecting interface, a memory card connecting interface, an IEEE1394 or a serial ATA connecting interface. The abovementioned memory card connecting interface may be a MS memory card connecting interface, a XD memory card connecting interface or a SD memory card connecting interface.

The microcontroller 12 is electrically connected to the connecting interface 11 and can receive commands from the host 2 via the connecting interface 11.

The memory 13 is electrically connected to the microcontroller 12. The memory 13 can be a NOR, a NAND or a AND flash memory, or a hard disk.

The hidden block 131 is adopted for storing a user's password and the hidden block 131 may be in a DOS format.

The first program block 132 is adopted for storing a password-identifying program and the first program block 132 may be in an ISO0660 format.

The general block 133 is provided for the host 2 to process data retrieval/storage there-from and the general block 133 may be in a DOS format.

The second program block 134 is adopted for storing a switch program and other application programs and the second program block 134 may be in an ISO9660 format.

The security block 135 is provided for the host 2 to process data retrieval/storage there-from and the security block 135 may be in a DOS format.

The abovementioned storage device 1 may comprise a portable disk, a memory card, a micro drive or a hard disk.

When the connecting interface 11 of the storage device 1 is electrically connected to the host 2, the storage device 1 informs to the host 2 that the first program block 132 and the general block 133 are available blocks and the second program block 134 and the security block 135 are unavailable blocks. Thus, a user can process data retrieval/storage in the general block 133 through the host 2. Because the second program block 134 and the security block 135 are unavailable blocks, therefore, the user is unable to process data retrieval/storage therein. If the user wishes to process data retrieval/storage in the security block 135, the password-identifying program in the first program block 132 must be executed first. Upon executing the password-identifying program, the user is asked to input a password from the host 2 for comparing with the user's password stored in the hidden block 131. When the password inputted by the user matches with the user's password stored in the hidden block 131, the electrical connection between the storage device 1 and the host 2 is cut off automatically, and then the electrical connection between the storage device 1 and the host 2 is automatically reconnected and the storage device 1 informs to the host 2 that the security block 135 and the second program block 134 are available blocks, and the general block 133 and the first program block 132 are unavailable blocks. Thus, the user can process data retrieval/storage in the security block 135. On the contrary, if the password inputted by the user mismatches with the user's password stored in the hidden block 131, the user will be denied to access the security block 135 and is only allowed to process data retrieval/storage in the general block 133. When the user wishes to replace the second program block 134 and the security block 135 in use by the general block 133 and the first program block 132, the switch program stored in the second program block 134 is executed first for terminating and then reconnecting the electrical connection between the storage device 1 and the host 2. After this action, the storage device 1 informs to the host 2 that the general block 133 and the first program block 132 are available blocks, and the security block 135 and the second program block 134 are unavailable blocks. The user is then allowed to process data retrieval/storage in the general block 133. Thus, the password-identifying program stored in the first program block 132 and the switch program stored in the second program block 134 allow the user to process data retrieval/storage in the general block 133 and the security block 135 without installing any driver program in the host 2 as required in the conventional art. Before matching the password inputted by the user with the user's password in the hidden block 131, the user cannot process data retrieval/storage in the security block 135. Thus, the security of the data stored in the security block 135 can be ensured.

Furthermore, the first program block 132 may also comprise an auto-execution program (autorun.inf) for opining the password-identifying program. Thus, when the storage device 1 is electrically connected to the host 2, the host 2 can automatically execute the password-identifying program stored in the storage device 1.

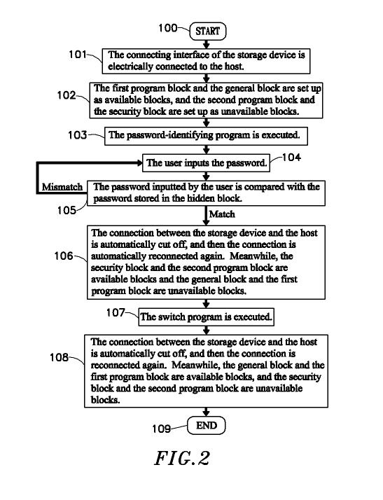

Hereinafter, the operating procedure of the storage device 1 is described with reference to FIGS. 1 and 2 as follows.

At step 100, the procedure starts.

At step 101, the connecting interface 11 of the storage device 1 is electrically connected to the host 2.

At step 102, the storage device 1 sets up the first program block 132 and the general block 133 of the memory 13 as available blocks and the second program block 134 and the security block 135 as unavailable blocks.

At step 103, the password-identifying program stored in the first program block 132 is executed.

At step 104, the user inputs a password.

At step 105, the password-identifying program compares the password inputted by the user with the user's password stored in the hidden block 131. If the two passwords match, the procedure proceeds to step 106; otherwise procedure returns to step 102.

At step 106, the electrical connection between storage device 1 and the host 2 is automatically cut off and then automatically reconnected again. Meanwhile, the storage device 1 sets up the security block 135 and the second program block 134 of the memory 13 as available blocks and the general block 133 and the first program block 132 as unavailable blocks.

At step 107, the switch program stored in the second program block 134 is executed.

At step 108, the electrical connection between storage device 1 and the host 2 is automatically cut off and then automatically reconnected again. Meanwhile, the storage device 1 sets up the general block 133 and the first program block 132 of the memory 13 as available blocks and the security block 135 and the second program block 134 as unavailable blocks.

At step 109, the procedure ends.

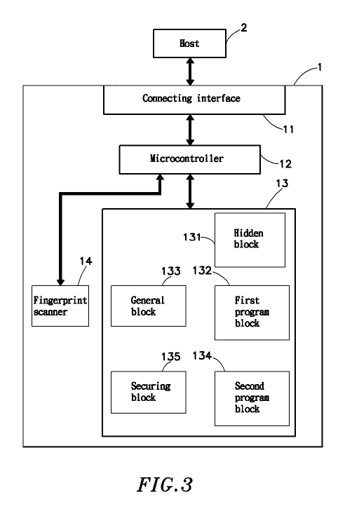

Referring to FIG. 3, the storage device 1 comprises the connection interface 11 connected to the microcontroller 12. The microcontroller 12 is connected respectively to a fingerprint scanner 14 and the memory 13. The memory 13 comprises the hidden block 131, the first program block 132, the general block 133, the second program block 134 and the security block 135.

The hidden block 131 is adopted for storing a user's fingerprint record and the hidden block 131 may be in a DOS format.

The first program block 132 is adopted for storing a fingerprint-identifying program and a fingerprint scanning program and the first program block 132 may be in an ISO9660 format.

The general block 133 is provided for the host 2 to process data retrieval/storage there-from and the general block 133 may be in a DOS format.

The second program block 134 is adopted for storing a switch program and other application programs and the second program block 134 may be in an ISO9660 format.

The security block 135 is provided for the host 2 to process data retrieval/storage there-from and the security block 135 may be in a DOS format.

When the connecting interface 11 of the storage device 1 is electrically connected to the host 2, the storage device 1 informs to the host 2 that the first program block 132 and the general block 133 are available blocks, and the second program block 134 and the security block 135 are unavailable blocks. Thus, a user can process data retrieval/storage in the general block 133 through the host 2. Because the second program block 134 and the security block 135 are unavailable blocks, therefore, the user is unable to process data retrieval/storage therein. If the user wishes to process data retrieval/storage in the security block 135, the fingerprint-identifying program in the first program block 132 must to be executed first. Upon executing the fingerprint-identifying program, the user is asked to input a fingerprint through the fingerprint scanner 14 for compare with the user's fingerprint record stored in the hidden block 131 and the fingerprint scanner 14 is driven by the fingerprint scanning program stored in the first program block 132. When the fingerprint inputted by the user matches with the user's fingerprint record stored in the hidden block 131, the electrical connection between the storage device 1 and the host 2 will cut off automatically, and then the electrical connection between the storage device 1 and the host 2 is automatically reconnected and the storage device 1 informs to the host 2 that the security block 135 and the second program block 134 are available blocks, and the general block 133 and the first program block 132 are unavailable blocks. Thus, the user can process data retrieval/storage in the security block 135. On the contrary, if the fingerprint inputted by the user mismatches with the user's fingerprint record stored in the hidden block 131, the user will be denied to access the security block 135 and is only allowed to process data retrieval/storage in the general block 133. When the user wishes to replace the security block 135 and the second block 134 in use by the general block 133 and the first program block 132, the switch program stored in the second program block 134 is executed first for terminating and then reconnecting the electrical connection between the storage device 1 and the host 2. After this action, the storage device 1 informs to the host 2 that the general block 133 and the first program block 132 are available blocks, and the security block 135 and the second program block 134 are unavailable blocks. The user is then allowed to process data retrieval/storage in the general block 133. Thus, the fingerprint-identifying program stored in the first program block 132 and the switch program stored in the second program block 134 allow the user to process data retrieval/storage in the general block 133 and the security block 135 without installing any driver program in the host 2 as required in the conventional art. Before matching the fingerprint inputted by the user with the user's fingerprint record in the hidden block 131, the user cannot process data retrieval/storage in the security block 135. Thus, the security of the data stored in the security block 135 can be ensured.

Furthermore, the first program block 132 may also comprise an auto-execution program (autorun.inf) for opening the fingerprint-identifying program. Thus, when the storage device 1 is electrically connected to the host 2, the host 2 can automatically execute the fingerprint-identifying program stored in the storage device 1.

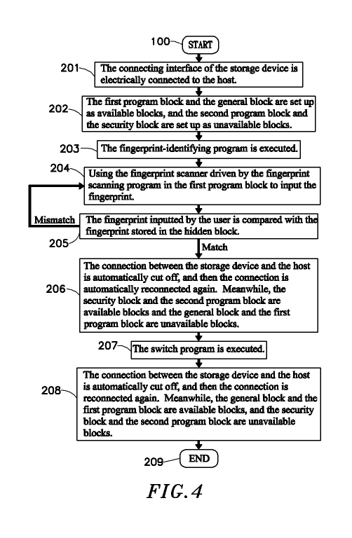

Hereinafter, the operation procedure of the storage device 1 is described with reference to FIGS. 3 and 4 as follows.

At step 200, the procedure starts.

At step 201, the connecting interface 11 of the storage device 1 is electrically connected to the host 2.

At step 202, the storage device 1 sets up the first program block 132 and the general block 133 of the memory 13 as the available blocks and the second program block 134 and the security block 135 as the unavailable blocks.

At step 203, the fingerprint-identifying program stored in the first program block 132 is executed.

At step 204, the user inputs a fingerprint through the fingerprint scanner 14, and the fingerprint scanner 14 is driven by the fingerprint scanning program stored in the first program block 132.

At step 205, the fingerprint-identifying program compares the fingerprint inputted by the user with the user's fingerprint record stored in the hidden block 131. If the two fingerprints matches, the procedure proceeds to step 206; otherwise the procedure returns to step 204.

At step 206, the electrical connection between the storage device 1 and the host 2 is automatically cut off and then automatically reconnected again. Meanwhile, the storage device 1 sets up the security block 135 and the second program block 134 of the memory 13 as available blocks and the general block 133 and the first program block 132 as unavailable blocks.

At step 207, the switch program stored in the second program block 134 is executed.

At step 208, the electrical connection between the storage device 1 and the host 2 is automatically cut off and then automatically reconnected again. Meanwhile, the storage device 1 sets up the general block 133 and the first program block 132 of the memory 13 as available blocks and the security block 135 and the second program block 134 as unavailable blocks.

At step 209, the procedure ends.

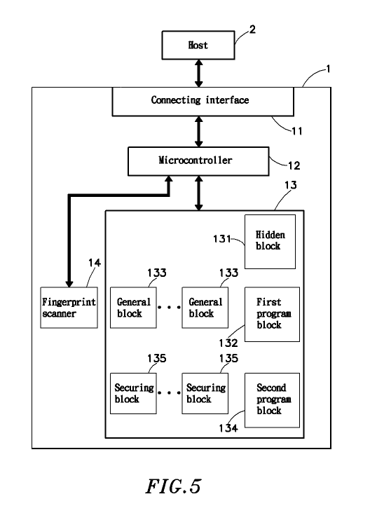

Referring to FIG. 5, the memory 13 comprises a plurality of general blocks 133 and a plurality of security blocks 135. So, the password-identifying program or the fingerprint-identifying program can be applied according to the procedure described above to control the plurality of the general blocks 133 and the plurality of security blocks 135. Furthermore, the second program block 134 may be adopted for storing an encoder/decoder program, a computer lock-up program, a monitor lock-up program or a compression/decompression program to implement a variety of functions in the storage device 1.

Accordingly the portable storage device 1 of the present invention at least has the following advantages.

1. The password-identifying program or the fingerprint-identifying program stored in the first program block 132 of the storage device 1 is used for comparing the user's identity record stored in the hidden block 131 to ensure the security of the data stored in the security block 135. Besides, there is no need to install any driver program in the host 2.

2. The password-identifying program or the fingerprint-identifying program stored in the first program block 132 of the storage device 1 is used for controlling the access to general block 133 and the security block 135. Thus, the user can store data that need to keep secret in the same block, and the disadvantage of only encoding/decoding a specific directory or a file may be effectively eliminated.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A portable storage device, comprising:
a connecting interface, electrically connected to a host for transmitting a command;
a microcontroller, electrically connected to said connecting interface and adopted for executing said command transmitted from said host; and
a memory, comprising a hidden block adopted for storing a user's password, a first program block adopted for storing a password-identifying program, at least one general block provided for allowing said host to process data retrieval/storage there-from and at least one security block provided for allowing said host, wherein a user's password is stored in said hidden block and a password-identifying program is stored in said first program block, wherein when said host executes said password-identifying program, a user is asked to input a password and said password-identifying program compares said password inputted by the user with said user's password stored in said hidden block, and wherein when said password inputted by the user matches with said user's password stored in said hidden block, the user is allowed to access data stored in said security block to process data retrieval/storage therein.

2. The portable storage device as claimed in claim 1, wherein said blocks are in an ISO9660 format or in a DOS format.

3. The portable storage device as claimed in claim 1, wherein said connecting interface comprises a USB connecting interface, an IEEE1394, a serial ATA connecting interface or a memory card connecting interface.

4. The portable storage device as claimed in claim 1, wherein said memory comprises a flash memory or a hard disk.

5. The portable storage device as claimed in claim 1, wherein said storage device comprises a portable disk, a memory card, a micro drive or a hard disk storage device.

6. The portable storage device as claimed claim 1, wherein said first program block further comprises an auto-execution program to automatically execute said password-identifying program when said storage device is connected to said host.

7. The portable storage device as claimed in claim 1, wherein said memory further comprises a second program block.

8. The portable storage device according to claim 7, wherein when said password inputted by the user matches with said user's password stored in said hidden block, connection between said storage device and said host is automatically terminated and then reconnected so that access to said security block and said second program block is implemented and said storage device informs to said host that said security block and said second program block are available blocks and said general block and said first program block are unavailable blocks.

9. The portable storage device according to claim 7, wherein said second program block comprises a switch program or other application programs stored therein.

10. The portable storage device according to claim 9, wherein said switch program is capable of terminating and then reconnecting connection between said storage device and said host during operation so as said storage device to inform said host that said general block and said first program block are available blocks, and said security block and said second program block are unavailable blocks.

11. A portable storage device, comprising:
a connecting interface, electrically connected to a host for transmitting a command; a microcontroller, electrically connected to said connecting interface and adopted for executing said command transmitted from said host;
a fingerprint scanner, electrically connected to said microcontroller; and
a memory, comprising a hidden block, a first program block, a general block and a security block, wherein a user's fingerprint record is stored in said hidden block and a fingerprint scanning program and a fingerprint-identifying program are stored in said first program block, wherein when said host executes said fingerprint-identifying program, a user is asked to input a fingerprint via said fingerprint scanner and said fingerprint-identifying program compares said fingerprint inputted by the user with said user's fingerprint record stored in said hidden block, and wherein when said fingerprint inputted by the user matches with said user's fingerprint record stored in said hidden block, the user is allowed to access data stored in said security block to process data retrieval/storage therein.

12. The portable storage device as claimed in claim 11, wherein said blocks are in an ISO9660 format or in a DOS format.

13. The portable storage device as claimed in claim 11, wherein said connecting interface comprises a USB connecting interface, an IEEE1394, a serial ATA connecting interface or a memory card connecting interface.

14. The portable storage device as claimed in claim 11, wherein said memory comprises a flash memory or a hard disk.

15. The portable storage device as claimed in claim 11, wherein said storage device comprises a portable disk, a memory card, a micro drive or a hard disk storage device.

16. The portable storage device according to claim 11, wherein said first program block further comprises an auto-execution program to automatically execute said fingerprint-identifying program when said storage device is connected to said host.

17. The portable storage device according to claim 11, wherein said memory further comprises a second program block.

18. The portable storage device according to claim 17, wherein when said fingerprint inputted by the user matches with said user's fingerprint record stored in said hidden block, connection between said storage device and said host is automatically terminated and then reconnected so that access to said security block and said second program block is implemented and said storage device informs to said host that said security block and said second program block are available blocks, and said general block and said first program block are unavailable blocks.

19. The portable storage device according to claim 17, wherein said second program block comprises a switch program or other application programs stored therein.

20. The portable storage device according to claim 17, wherein said switch program is capable of terminating and then reconnecting connection between said storage device and said host during operation so as to said storage device to inform said host that said general block and said first program block are available blocks and said security block and said second program block are unavailable blocks.
